(19) United States
(12) Patent Application Publication
(10) Pub. No.: US 2020/0013131 A1
(43) Pub. Date: Jan. 9, 2020

(54) OPTIMIZING INFRASTRUCTURE ENHANCEMENTS FOR EVACUATION PLANNING

(71) Applicant: THE REGENTS OF THE UNIVERSITY OF MICHIGAN, Ann Arbor, MI (US)

(72) Inventors: Pascal VAN HENTENRYCK, Ann Arbor, MI (US); Julia ROMANSKI, Cambridge, MA (US); Kunal KUMAR, Ghent (BE)

(21) Appl. No.: 16/468,591

(22) PCT Filed: Dec. 11, 2017
(86) PCT No.: PCT/US2017/065530

§ 371 Date: Jun. 11, 2019

Related U.S. Application Data
(60) Provisional application No. 62/432,602, filed on Dec. 11, 2016.
(60) Provisional application No. 62/456,918, filed on Feb. 9, 2017.

(51) Int. Cl. G06Q 50/26; G06Q 10/04; G06F 17/50

(52) U.S. Cl. CPC G06Q 50/26; G06F 2217/16; G06F 17/5009; G06Q 10/047

(57) ABSTRACT

With rapid population growth and urbanization, emergency services in various cities around the world worry that the current transportation infrastructure is no longer adequate for large-scale evacuations. This disclosure considers how to mitigate this issue through infrastructure upgrades, such as the additions of lanes to road segments and the raising of bridges and roads. This disclosure proposes a MIP model for deciding the most effective infrastructure upgrades as well as a Benders decomposition approach where the master problem jointly plans the upgrades and evacuation routes and the subproblem schedules the evacuation itself.

### CROSS-REFERENCE TO RELATED APPLICATIONS

This application claims the benefit of U.S. Provisional Application No. 62/456,918, filed on Feb. 9, 2017 and U.S. Provisional Application No. 62/432,602 filed on Dec. 11, 2016. The entire disclosures of each of the above applications are incorporated herein by reference.

### FIELD

The present disclosure relates to an optimizing infrastructure enhancements for evacuation planning.

### BACKGROUND

With rapid population growth and increased urbanization, emergency services in various cities around the world worry that the current transportation infrastructure is no longer adequate for large-scale evacuations. In some cities, the infrastructure, and in particular the road network, has not kept up with population growth. This is especially worrisome given that existing infrastructure capacity is often well below the level what would be required for effective large-scale evacuations. Yet little research on evacuation planning includes the possibility of improving road infrastructure. Some studies use contraflows in order to increase road capacities. However other studies warn that the presence of contraflow lanes can lead to congestion due to drivers' unfamiliarity with lane reversal.

This disclosure attempts to fill this gap. For example, this disclosure studies how to upgrade the road network in order to maximize the number of evacuees reaching safety given an infrastructure budget. This study considers zone-based evacuation planning over convergent plans and two types of upgrades: adding lanes to selected road segments and raising road segments so that they survive the flood. Zone-based evacuations assign a unique path to safety to each residential area, which makes mobilization and evacuation operations simpler to execute. Convergent plans ensure that there are no forks in the evacuation graph, making plan compliance simpler to enforce. Convergent plans also eliminate forks in the evacuation graph, which may lead to congestion due to driver hesitation.

To decide which infrastructure enhancements to perform, two approaches are presented: 1) a MIP model whose decision variables are the infrastructure investment, the evacuation paths, and the evacuation schedule; and 2) a Benders decomposition whose master variables are the investment decisions and the evacuation paths and the subproblem variables denote the evacuation schedule.

Experimental results evaluate the practicability of the approaches on the case study concerning a flood event in the Hawkesbury-Nepean region in West Sydney. The results indicate the practicability of the Benders decomposition approach which significantly outperforms the MIP model and exhibits small optimality gaps in reasonable time. The results also report on the tradeoff between the quality of the evacuation plans and the budget.

### SUMMARY

This section provides a general summary of the disclosure, and is not a comprehensive disclosure of its full scope or all of its features.

A method is provided for determining an evacuation plan. As a starting point, an evacuation scenario is presented with an evacuation graph, where the evacuation graph is comprised of evacuation nodes, transit nodes and safe nodes interconnected by edges, such that each evacuation node has a number of evacuees, each safe node is a possible destination for evacuees, the transit nodes are locations evacuees pass through when traveling from the evacuation nodes to the safe nodes, and each edge represents a path between nodes and has a capacity for evacuees traversing that path. The method includes: segmenting an evacuation time period into a plurality of time blocks; constructing a time-expanded graph from the evacuation graph by duplicating each node in the evacuation graph for each time block in the plurality of time blocks and connecting an origin node in a given time period via an edge to a destination node at a subsequent time period as determined by the time needed to traverse this edge, where each edge in the time-expanded graph includes a continuous flow variable representing flow on that edge, and an upgrade variable indicating an infrastructure upgrade to the path represented by that edge; and determining a set of convergent subgraphs of the time-expanded graph that maximize the flow of evacuees from all of the evacuation nodes to the safe nodes and identifies any infrastructure upgrades along the route, where each evacuation node is found in at least one convergent subgraphs in the set of convergent subgraphs.

In one aspect, departure times for evacuees are scheduled that maximizes the flow of evacuees from the evacuation nodes to the safe nodes in the convergent graph. Scheduling departure times for evacuees requires flow conservation at each of the transit nodes in the master problem graph and enforces aggregated capacity associated with each edge in the master problem graph. Departure times for evacuees may be scheduled using a linear programming method.

In another aspect, infrastructure upgrade identified from the set of convergent subgraphs are implemented along the routes.

In one embodiment, each edge in the evacuation graph represents a road between nodes, such that the infrastructure upgrades are further defined as adding lanes to an existing road or elevating the road. In this case, a model is defined for solving the evacuation scenario, where an objective of the model is to maximize the flow of evacuees from all of the evacuation nodes to the safe nodes and decision variables in the model include a binary variable indicating whether a given edge is selected for inclusion in a route between a given evacuation node and a given safe node, a continuous flow variable representing flow on the given edge, a first upgrade variable indicating a number of lanes added to the road represented by the given edge and a second upgrade variable indicating whether the road is available at a given time according to its elevation.

To determine a set of convergent subgraphs, for each edge in the evacuation graph, aggregating the capacity of the corresponding one or more edges in the time-expanded graph over the evacuation time period and thereby form a master problem graph, such that each edge in the master problem graph includes an aggregated capacity for evacuees traversing that edge. In one embodiment, the set of convergent subgraphs is determined by requiring flow conservation at each of the transit nodes in the time-expanded graph and enforces aggregated capacity associated with each edge in the time-expanded graph. In another embodiment, the set of convergent subgraphs are determined by constraining flow on a given edge by capacity, where capacity increases linearly with number of lanes comprising the road. The set of convergent subgraphs may be determined using a branch and bound method.

The method may further include: determining a first number of evacuees reaching the safe nodes within the evacuation time period using the set of convergent subgraphs; determining a second number of evacuees reaching the safe nodes within the evacuation time period using the scheduled departure times; comparing the first number of evacuees to the second number of evacuees; and adding constraints to the step of determining a set of convergent subgraphs and repeating steps (d) and (e) until the first number of evacuees matches the second number of evacuees. Adding constraints further comprises generating Bender cuts and adding the Bender cuts as a constraint to the step of determining a set of convergent subgraphs.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIGS. 1A-1C show a modeling of an evacuation planning problem;

FIG. 2 is a flowchart depicting an example method for determining a large-scale prescriptive evacuation plan that uses Benders decomposition;

FIG. 3 is a graph showing the percentage of people evacuated for given budgets; and

FIG. 4 is a diagram of an example system for determining and implementing an evacuation plan.

Corresponding reference numerals indicate corresponding parts throughout the several views of the drawings.

### DETAILED DESCRIPTION

Example embodiments will now be described more fully with reference to the accompanying drawings.

By way of background, an evacuation scenario is represented by an evacuation graph [symbol] =( [symbol] =ε∪ [symbol] ∪ [symbol] ), where [symbol] , and [symbol] are the set of evacuation, transit, and safe nodes respectively, and [symbol] is the set of arcs. Each evacuation node i is associated with a demand dᵢ. Each arch e is labeled with its travel time sₑ, its capacity uₑ, and the time fₑ when it becomes flooded over. The evacuation scenario can be derived from maps and plans contained in a database maintained by a municipality or other government entity. While reference is made throughout this disclosure to flooding, it readily understood that the concepts are adaptable to other causes for an evacuation, including but not limited to fire, hurricane, chemical spill, violent uprising, etc.

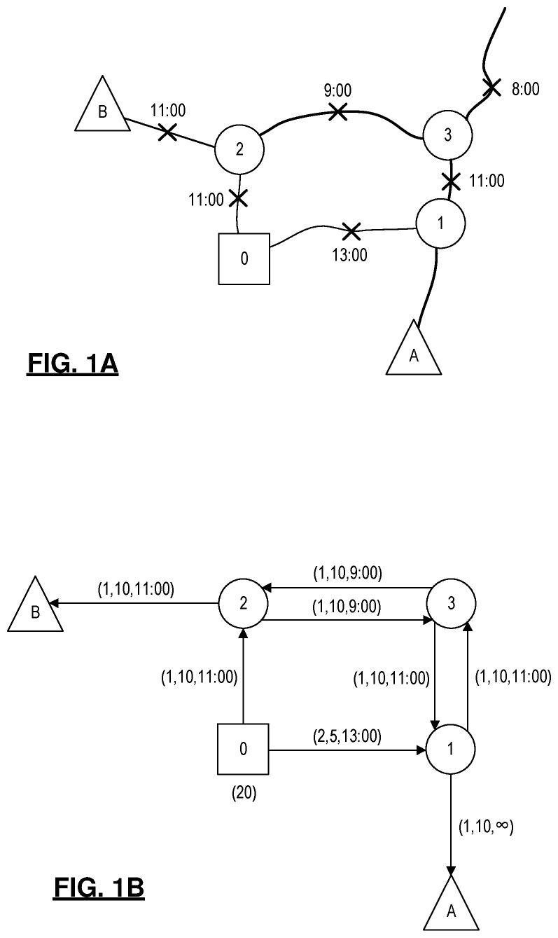

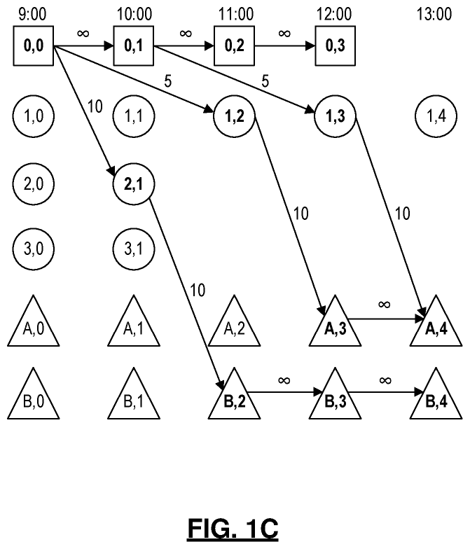

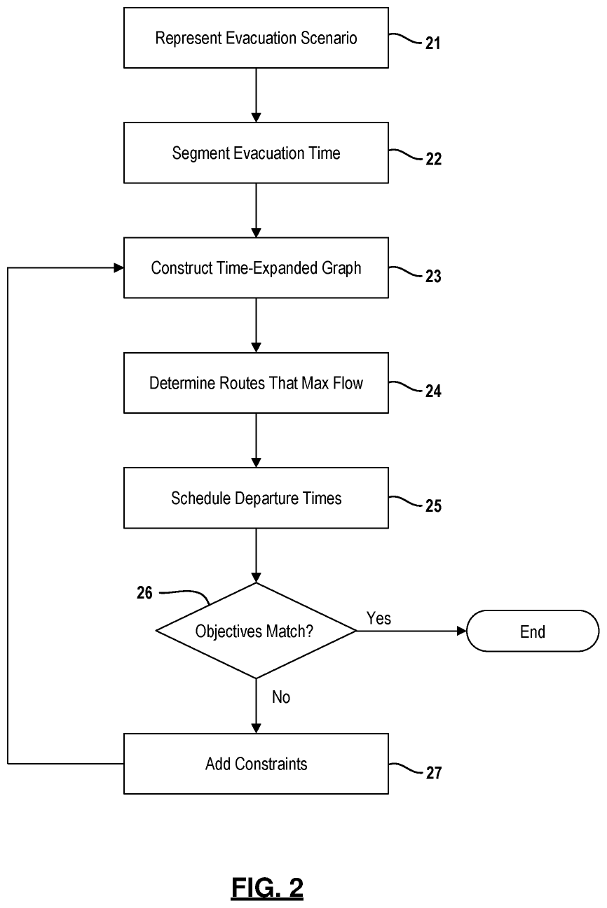

FIG. 1A-1C gives an example of how an evacuation scenario is modeled. FIG. 1A illustrates an evacuation scenario that has one evacuation node labeled “0”, and two safe nodes labelled “A” and “B”. The times on each arc indicate when the flood would arrive if the road were not elevated. Flood times can be derived using models and/or simulation software. FIG. 1B is an evacuation graph based on the evacuation scenario. There is a demand of 20 vehicles from the evacuation node labeled “0”. For illustrating the notation, Arc (0, 1) has a travel time of 2 minutes and a capacity of 5 vehicles/minute, and will be flooded at 13:00 if it is not elevated. This notation is extended to the other arcs as well. Each arc/edge represent a path between nodes. Although this example considers roads, other types of paths (e.g., railways) are also contemplated by this disclosure.

FIG. 1C illustrates a time-expanded graph for this scenario. The spatio-temporal aspect of the problem are expressed through the time-expanded graph [symbol] ^{x}=( [symbol] ^{x}=ε^{x}∪T^{x}∪S^{x}, [symbol] ^{x}). In the time-expanded graph, there is a copy of each static node for each discrete time step within the horizon. The horizon is noted across the top of the graph in one hour increments starting at 9:00 and ending at 13:00. The set [symbol] ^{x} contains edges eₜ=(iₜ,jₜ₊ₛ_{_{(i,j)}}) corresponding to static edges e=(i,j), for each such pair of times within the horizon. The safe nodes “A” and “B” are also enumerated along the bottom of the graph.

In an example embodiment, there are two possible infrastructure upgrades for the roads: adding new lanes and elevating roads. Each lane has an existing number of lanes nₑ, as well as a maximum number of lanes that can be added 4. It is assumed that capacity increases linearly with the number of lanes. Each road segment can also be elevated, extending its availability by a given amount of time. The costs of the upgrades are given by cₗ(e) for adding a single lane to arc e and cₑ(e) for evaluting arc e to extend its availability by a single time step. These costs are given per unit length. Other types of infrastructure upgrades are also contemplated by this disclosure and can be modeled in a similar way. For example, protecting roads with sandbags along the side of the roads would also extend availability of a given road segment.

The convergent evacuation network design problem is defined. Specifically, the convergent evacuation network design problem (CENDP) is defined as finding a convergent evacuation plan that includes two kinds of infrastructure upgrades: lane additions and road elevations.

First, a mixed-integer programming (MIP) model is presented for solving the CENDP. The decision variables in the model are as follows: variable xₑ is binary and represents whether arc e is selected, variable φₑ_{ₜ} is continuous and denotes the flow on arc eₜ∈ [symbol] ^{x}, variable zₑ is integer and indicates the number of lanes added to arc e, and variable vₑ_{ₜ} is binary and indicates whether arc e is available at time t according to its road elevation. Objective (1) below maximizes the total flow of evacuees, with δ⁻(k) and δ⁺(k), respectively, denoting the set of incoming and outgoing edges of node k. For simplicity, assume that all roads have the same limit n⁺ on the number of additional lanes and that the upgrade costs per unit distance are the same for all edges (cₜ and cₑ). It is understood how to generalize the model to remove these assumptions. The MIP model operates on the expanded graph and is given by

$$\begin{matrix}max {\sum }_{k ∈ ɛ} {\sum }_{{e}_{t} ∈ δ + ( k )} {ϕ}_{{ɛ}_{t}} & ( 1 ) \\ \begin{matrix}s . t . {\sum }_{{e}_{t} ∈ δ - ( i )} {ϕ}_{{e}_{t}} - {\sum }_{{e}_{t} ∈ δ + ( i )} {ϕ}_{{e}_{t}} = 0 & ∀ i ∈ {𝒯}^{x}\end{matrix} & ( 2 ) \\ \begin{matrix}{\sum }_{e ∈ δ + ( i )} {x}_{e} \leq 1 & ∀ i ∈ ɛ ⋃ 𝒯\end{matrix} & ( 3 ) \\ \begin{matrix}{ϕ}_{{e}_{t}} \leq {x}_{e} ( 1 + \frac{{n}^{+}}{{n}_{e}} ) {u}_{{e}_{t}} & ∀ e ∈ , ∀ t ∈\end{matrix} & ( 4 ) \\ \begin{matrix}{ϕ}_{{e}_{t}} \leq {v}_{{e}_{t}} ( 1 + \frac{{z}_{e}}{{n}_{e}} ) {u}_{{e}_{t}} & ∀ e ∈ , ∀ t ∈\end{matrix} & ( 5 ) \\ \begin{matrix}{\sum }_{{ϵ}_{t} ∈ δ + ( k )} {ϕ}_{{e}_{t}} \leq {d}_{k} & ∀ k ∈ ɛ\end{matrix} & ( 6 ) \\ \begin{matrix}{v}_{{e}_{t}} \geq {v}_{{e}_{t + 1}} & ∀ {e}_{t} , {e}_{t + 1} ∈ {x}^{}\end{matrix} & ( 7 ) \\ \begin{matrix}{v}_{{e}_{t}} = 1 & ∀ e ∈ A , ∀ t ∈ [ 0 , {f}_{e} )\end{matrix} & ( 8 ) \\ \begin{matrix}{\sum }_{t = {f}_{e}}^{h} {v}_{{e}_{t}} = {w}_{e} & ∀ e ∈\end{matrix} & ( 9 ) \\ {\sum }_{e ∈} {l}_{e} ( {c}_{l} \cdot {z}_{e} + {c}_{e} \cdot {w}_{e} ) \leq & ( 10 ) \\ \begin{matrix}{z}_{e} \leq {n}^{+} & ∀ e ∈\end{matrix} & ( 11 ) \\ \begin{matrix}{ϕ}_{{e}_{t}} \geq 0 & ∀ e ∈\end{matrix} & ( 12 ) \\ \begin{matrix}{x}_{e} ∈ \{ 0 , 1 \} & ∀ e ∈\end{matrix} & ( 13 ) \\ \begin{matrix}{z}_{e} , {w}_{e} ∈ {ℤ}^{+} & ∀ e ∈\end{matrix} & ( 14 ) \\ \begin{matrix}{v}_{{e}_{t}} ∈ \{ 0 , 1 \} & ∀ e ∈ , ∀ t ∈\end{matrix} & ( 15 )\end{matrix}$$

Constraints (2) enforce flow conservation at each transit node, constraints (3) impose that the evacuation plan satisfies a tree structure (thus producing a convergent plan), and constraints (4) ensure that evacuation flows only travel on selected edges. Constraints (5) limit the flows to the edge capacities and capture the fact that the road capacity increases linearly with the number of lanes. Constraints (6) make sure that the total flow of evacuees of each evacuation node does not exceed the node demand. Constraints (7) ensure that road blockages due to the flood persists until the time horizon and constraints (8) express the road availability before the onset of the flood. Constraints (9) capture the possibility of raising a road for a number of time steps. Constraint (10) is the budget constraint, where lₑ in the length of the arc e and wₑ is number of units of elevation upgrades on e. It is important to note that constraints (4) and (5) are nonlinear as they contain products of two decision variables. However, these products can be linearized since variables vₑ_{ₜ} are binary.

A second approach considered in this disclosure is a Benders decomposition which separates the decision variables in two stages. The Restricted Master Problem (RMP) selects a set of convergent paths and infrastructure upgrades. The Subproblem (SP) schedules the departure times of evacuees. The restricted master problem remains a MIP model but on the evacuation graph and not its time-expanded counterpart. The subproblem is a linear program on the time-expanded graph.

A Benders decomposition proceeds as follows. First, solve the RMP to obtain optimal values for the RMP decision variables. Next, solve the SP with the RMP variables fixed to their optimal values. If the objective values of the RMP and SP coincide, the solution is optimal; otherwise, a Benders cut is generated from the optical solution of the SP and added to the RMP and the process is iterated. In the Benders decomposition considered here, the SP is always feasible and the Benders constraints are optimality-based cuts. The RMP always returns an upper bound to the optimal number of evacuees reaching safety, while the SP returns a feasible solution.

FIG. 2 presents an overview of the Benders decomposition approach. An evacuation scenario is first represented at 21 with an evacuation graph. The evacuation graph is comprised of evacuation nodes, transit nodes and safe nodes interconnected by edges. Each evacuation node has a number of evacuees (i.e., a demand). Each safe node is a possible destination for evacuees. Transit nodes are locations evacuees pass through when traveling from the evacuation nodes to the safe nodes, and each edge includes a capacity for evacuees traversing that edge. It is readily understood that other parameters may also be associated with the nodes and/or edges.

An evacuation time period is defined and segmented at 22 into a plurality of time blocks. For example, the evacuation period may be given as four hours or forty-eight hours. In one embodiment, the evacuation period is divided into five minute increments although shorter or longer time increments are contemplated by this disclosure.

From the evacuation graph, a time-expended graph is constructed at 23. In the example embodiment, the time-expanded graph is constructed by duplicating each node in the evacuation graph for each time block in the evacuation period. Edges in the evacuation graph are also duplicated. More specifically, for a given origin node in a given time period, the origin node is connected via an edge to a destination node at a subsequent time period as determined by the time needed to traverse this edge. That is, edges are added at each time increment so long as the origin node and route remain available for use. For example, nodes 2 and 3 are only available until 11:00. At time increments after 11:00, these nodes are not included in the graph. In the time-expanded graph, each edge includes a continuous flow variable representing flow on that edge.

Furthermore, each edge in the static graph is associated with a binary variable indicating whether that edge is selected for inclusion in a route between a given evacuation node and a given safe node. It is also associated with an upgrade variable indicating an infrastructure upgrade to the path represented by that edge. In the example embodiment, the infrastructure upgrades are adding new lanes to the road and elevating the road. Again, other types of infrastructure upgrades fall within the scope of this disclosure. For each edge in the evacuation graph, capacity of the corresponding one or more edges in the time-expanded graph is aggregated over the evacuation time period, thereby forming a master problem graph. With reference to FIG. 1C, the aggregate capacity for the edge between node 0 and node 1 is 10 (i.e., 5+5); whereas, the aggregate capacity for the edge between node 1 and node A is 20 (i.e., 10+10). Thus, each edge in the master problem graph includes an aggregated capacity for evacuees traversing that edge.

Convergent paths are chosen from the master problem graph. That is, a set of convergent subgraphs are determined at 24 that maximize the flow of evacuees from all of the evacuation nodes to the safe nodes. In an example embodiment, the set of convergent subgraphs are identified using a branch and bound method although other graph search algorithms (e.g., branch and cut) are contemplated as well. As a result, a set of routes from each of the evacuation nodes to a safe node is determined. Each evacuation node is found in at least one convergent subgraphs in the set of convergent subgraphs and the set of convergent subgraphs forms a convergent graph. A first number of evacuees reaching the safe nodes within the evacuation time period can be determined using the convergent graph and the aggregated capacities from the master problem graph.

From the chosen paths, departure times for evacuees that maximize the flow of evacuees from the evacuation nodes to the safe nodes in the convergent graph are scheduled as indicated at 25. These departure times are computed by determining the flows from the duplicated evacuation zones over time, only using the selected paths and upgrades and never violating the capacity constraints of edges. In the example embodiment, linear programming is used to determine the objective function of the Subproblem which yields a second number of evacuees reaching the safe nodes within the evacuation time period as well as the departure times. It is also envisioned that network flow algorithms or other known methods may be used in place of linear programming.

The objective values of the solutions to the two optimization problems can then be compared at 26. For example, the number of evacuees reaching safe nodes using the convergent graph and the aggregated capacities from the master problem graph is compared to the number of evacuees reaching safe nodes based on the schedule departure times on the time-expanded graph. Because of the aggregated capacity in the restricted master problem, the first number of evacuees is an upper bound that will typically exceed the second number of evacuees reaching the same nodes within the evacuation time period. In many cases, the solution of the subproblem is not optimal and can be improved. Therefore, constraints are added to the restricted master problem at 27 and the process is repeated until the objective values for the restricted master problem and the subproblem match (i.e., the first number of evacuees equals the second number of evacuees). In the example embodiment, a Benders decomposition approach is used to generate cuts that remove less optimal segments along the convergent paths as will be further described below.

The Benders Decomposition approach is described in more detail. As mentioned previously, the restricted master problem (RMP) operates on the evacuation graph, not its time expansion. However, to produce reasonable evacuation plans and infrastructure improvements to seed the Benders decomposition, capacities are aggregated over time for each arc in the graph. This makes it possible to have a RMP which provides an upper bound to the optimal value, while still working on the evacuation graph. Besides the decision variables xₑ,zₑ, and vₑ_{ₜ}, the RMP also uses a variable ψₑ to represent the aggregate flow of evacuees over time along arc e. The RMP can be simplified by aggregating the decision variables vₑ_{ₜ}, but this formulation is kept for simplicity. The objective of the RMP is to maximize the aggregate flow from evacuation nodes to safe nodes within the time horizon, given the infrastructure upgrade budget. The RMP can thus be specified as follows and can really be seen as an aggregation of the MIP model:

$$\begin{matrix}max {\sum }_{k ∈ ɛ} {\sum }_{e ∈ δ + ( k )} {ψ}_{e} & ( 16 ) \\ \begin{matrix}s . t . {\sum }_{e ∈ δ - ( i )} {ψ}_{ϵ} - {\sum }_{e ∈ δ + ( i )} {ψ}_{e} = 0 & ∀ i ∈ 𝒯\end{matrix} & ( 17 ) \\ \begin{matrix}{\sum }_{e ∈ δ + ( i )} {x}_{e} \leq 1 & ∀ i ∈ ɛ ⋃ 𝒯\end{matrix} & ( 18 ) \\ \begin{matrix}{ψ}_{e} \leq {x}_{e} ( 1 + \frac{{n}^{+}}{{n}_{e}} ) {\sum }_{t ∈} {u}_{{e}_{t}} & ∀ e ∈\end{matrix} & ( 19 ) \\ \begin{matrix}{ψ}_{e} \leq ( 1 + \frac{{z}_{e}}{{n}_{e}} ) {\sum }_{t ∈} {v}_{{e}_{t}} \cdot {u}_{{e}_{t}} & ∀ e ∈\end{matrix} & ( 20 ) \\ \begin{matrix}{\sum }_{e ∈ δ + ( k )} {ψ}_{e} \leq {d}_{k} & ∀ k ∈ ɛ\end{matrix} & ( 21 ) \\ \begin{matrix}{v}_{{e}_{t}} \geq {v}_{{e}_{t + 1}} & ∀ {e}_{t} , {e}_{t + 1} ∈ {x}^{}\end{matrix} & ( 22 ) \\ \begin{matrix}{v}_{{e}_{t}} = 1 & ∀ e ∈ A , ∀ t ∈ [ 0 , {f}_{e} )\end{matrix} & ( 23 ) \\ \begin{matrix}{\sum }_{t = {f}_{e}}^{h} {v}_{{e}_{t}} \leq {w}_{e} & ∀ e ∈ A\end{matrix} & ( 24 ) \\ {\sum }_{e ∈} {l}_{e} ( {c}_{l} \cdot {z}_{e} + {c}_{e} \cdot {w}_{e} ) \leq & ( 25 ) \\ \begin{matrix}{z}_{e} \leq {n}^{+} & ∀ e ∈\end{matrix} & ( 26 ) \\ \begin{matrix}{ψ}_{e} \geq 0 & ∀ e ∈\end{matrix} & ( 27 ) \\ \begin{matrix}{x}_{e} ∈ \{ 0 , 1 \} & ∀ e ∈\end{matrix} & ( 28 ) \\ \begin{matrix}{z}_{e} , {w}_{e} ∈ {ℤ}^{+} & ∀ e ∈\end{matrix} & ( 29 ) \\ \begin{matrix}{v}_{{e}_{t}} ∈ \{ 0 , 1 \} & ∀ e ∈ , ∀ t ∈\end{matrix} & ( 30 )\end{matrix}$$

Constraints (17) impose the aggregate flow conservation at each transit node, constraints (18) enforce a tree structure, and constraints (19) ensure that flow will only be sent on selected arcs. Constraints (20) and (21) are the capacity and demand constraints, and constraint (25) is the budget constraint. The objective (16) maximizes the aggregate flow. Constraints (20) are nonlinear as they contain products of variables zₑ·vₑ_{ₜ}. These constraints can be linearized by replacing each product with a new variable pₑ_{ₜ} to represent such a product and adding the following constraints:

pₑ_{ₜ}≤zₑ ∀e∈ [symbol] ,∀t∈ [symbol] (31)

pₑ_{ₜ}≤vₑ_{ₜ}·n⁺ ∀e∈ [symbol] ,∀t∈ [symbol] (32)

pₑ_{ₜ}∈ [symbol] ⁺∀e∈ [symbol] ,∀t∈ [symbol] (33)

The RMP can be shown to be an upper bound to the CENDP. The proof relies on showing that any optimal solution to the CENDP is also a feasible solution to the RMP with the same objective value. Let Φ=({φₑ_{ₜ}},{xₑ},{zₑ},{vₑ_{ₜ}}) be an optimal solution to the CENDP, with an objective value of z(Φ). Clearly, constraints (18) and (22) through (30) in the RMP will be satisfied. Let

$${ψ}_{e} = {\sum }_{t ∈} {ϕ}_{{e}_{t}}$$

for each arc e∈ [symbol] . The objective value of the RMP will be the same as the CENDP because:

$$\begin{matrix}z ( Φ ) = {\sum }_{k ∈ ɛ} {\sum }_{{e}_{t} ∈ δ + ( k )} {ϕ}_{{e}_{t}} \\ = {\sum }_{k ∈ ɛ} {\sum }_{e ∈ δ + ( k )} {ϕ}_{{e}_{t}} \\ = {\sum }_{k ∈ ɛ} {\sum }_{e ∈ δ + ( k )} {ψ}_{e}\end{matrix}$$

Since Φ is a solution to the CENDP, we have

$$\begin{matrix}{\sum }_{{e}_{t} ∈ δ - ( i )} {ϕ}_{{e}_{t}} - {\sum }_{{e}_{t} ∈ δ + ( i )} {ϕ}_{{e}_{t}} = 0 & ∀ i ∈ {𝒯}^{x} \\ ⇒ {\sum }_{e ∈ δ - ( i )} {ϕ}_{{e}_{t}} - {\sum }_{e ∈ δ + ( i )} {ϕ}_{{e}_{t}} = 0 & ∀ i ∈ 𝒯 \\ ⇒ {\sum }_{e ∈ δ - ( i )} {ψ}_{e} - {\sum }_{e ∈ δ + ( i )} {ψ}_{e} = 0 & ∀ i ∈ 𝒯\end{matrix}$$

So the constraints (17) are satisfied. Similarly,

$$\begin{matrix}{ϕ}_{{e}_{t}} \leq {x}_{e} ( 1 + \frac{{n}^{+}}{{n}_{e}} ) {u}_{{e}_{t}} & ∀ e ∈ , ∀ t ∈ \\ ⇒ {ϕ}_{{e}_{t}} {x}_{e} ( 1 + \frac{{n}^{+}}{{n}_{e}} ) {u}_{{e}_{t}} & ∀ e ∈ \\ ⇒ {ψ}_{e} \leq {x}_{e} ( 1 + \frac{{n}^{+}}{{n}_{e}} ) {u}_{{e}_{t}} & ∀ e ∈\end{matrix}$$

Satisfying constraints (19). Also

$$\begin{matrix}{ϕ}_{{e}_{t}} \leq {v}_{{e}_{t}} ( 1 + \frac{{z}_{e}}{{n}_{e}} ) {u}_{{e}_{t}} & ∀ e ∈ , ∀ t ∈ \\ ⇒ {ϕ}_{{e}_{t}} {v}_{{e}_{t}} ( 1 + \frac{{z}_{e}}{{n}_{e}} ) {u}_{{e}_{t}} & ∀ e ∈ , ∀ t ∈ \\ ⇒ {ψ}_{e} \leq ( 1 + \frac{{z}_{e}}{{n}_{e}} ) {v}_{{e}_{t}} \cdot {u}_{{e}_{t}} & ∀ e ∈\end{matrix}$$

Finally,

$$\begin{matrix}{\sum }_{{e}_{t} ∈ δ + ( k )} {ϕ}_{{e}_{t}} \leq {d}_{k} & ∀ k ∈ ɛ \\ ≡ {\sum }_{{e}_{t} ∈ δ + ( k )} {ϕ}_{{e}_{t}} \leq {d}_{k} & ∀ k ∈ ɛ \\ ⇒ {\sum }_{{e}_{t} ∈ δ + ( k )} {ψ}_{e} \leq {d}_{k} & ∀ k ∈ ɛ\end{matrix}$$

The RMP produces a convergent evacuation graph [symbol] with infrastructure upgrades, specified by the optimal values x̅_{c}, z̅ₑ, and v̅ₑ_{ₜ}, for the RMP decision variables, xₑ, zₑ, and vₑ_{ₜ}. The SP uses these optimal values to determine the departure times of evacuees in the expanded graphs maximizing the number of evacuees reaching safety. The SP can be formulated as follows:

$$\begin{matrix}\begin{matrix}max {\sum }_{k ∈ ɛ} {\sum }_{{e}_{t} ∈ δ + ( k )} & {ϕ}_{{ϵ}_{t}}\end{matrix} & ( 34 ) \\ \begin{matrix}s . t . {\sum }_{{e}_{t} ∈ δ - ( i )} {ϕ}_{{ϵ}_{t}} - {\sum }_{{e}_{t} ∈ δ + ( i )} {ϕ}_{{ɛ}_{t}} = 0 & ∀ i ∈ {𝒯}^{x}\end{matrix} & ( 35 ) \\ \begin{matrix}{ϕ}_{{e}_{t}} \leq {\overline{x}}_{e} \cdot {u}_{{e}_{t}} ( 1 + \frac{{n}^{+}}{{n}_{e}} ) & ∀ e ∈ , ∀ t ∈\end{matrix} & ( 36 ) \\ \begin{matrix}{ϕ}_{{e}_{t}} \leq {\overline{v}}_{{e}_{t}} \cdot {u}_{{e}_{t}} ( 1 + \frac{{\overline{z}}_{e}}{{n}_{e}} ) & ∀ e ∈ , ∀ t ∈\end{matrix} & ( 37 ) \\ \begin{matrix}{\sum }_{{e}_{t} ∈ δ + ( k )} {ϕ}_{{e}_{t}} \leq {d}_{k} & ∀ k ∈ ɛ\end{matrix} & ( 38 ) \\ \begin{matrix}{ϕ}_{{e}_{t}} \geq 0 & ∀ e ∈ {x}^{}\end{matrix} & ( 39 )\end{matrix}$$

Constraints (35) are the flow conservation constraints. Constraints (36) ensure that flow will only be sent on edges in the network. Constraints (37) and (38) are the capacity and demand constraints. Note that the right-hand sides of constraints (36), (37), and (38) are constants. The objective (34) maximizes the flow.

After each iteration of the RMP and SP, and whenever the objective value of the SP is smaller than the objective value of the RMP, the Benders decomposition algorithm generates a cut of the form:

$$z \leq {x}_{e} ( 1 + \frac{{n}^{+}}{{n}_{e}} ) {u}_{{e}_{t}} \cdot {y}_{{e}_{t}} + ( {v}_{{e}_{t}} \cdot {u}_{{e}_{t}} + \frac{{p}_{{e}_{t} \cdot } {u}_{{e}_{t}}}{{n}_{e}} ) {y}_{{e}_{t}}^{′} + {\sum }_{k ∈ ɛ} {d}_{k} \cdot {y}_{k} \qquad ( 40 )$$

where { [symbol] ₑ_{ₜ}}, { [symbol] ₑ_{ₜ}′}, and { [symbol] k} are the dual variables associated with SP constraints (36), (37), and (38) respectively. These constraints accumulate in the RMP, which remains an upper bound to the CENDP since the Benders cuts are valid and do not remove optimal solutions.

It is well-known that a Benders decomposition with a flow-based subproblem may be slow to converge, as the SP may have many optimal solutions. Hence many Benders cuts may need to be generated. In one aspect, to strengthen the Benders cuts, the Magnanti-Wong method may be used to generate Pareto-optimal cuts for the restricted master problem. A Pareto-optimal cut is defined as a cut that is not dominated by any other cut for a given iteration of the decomposition. Denote by χ the convex hull of the feasible solutions to the RMP, i.e., feasible assignments for variables xₑ,zₑ, and vₑ_{ₜ}. The Magnanti-Wong method uses a core point of χ in order to generate a Pareto-optimal cut, i.e., a point x⁰ in the interior of χ. To generate a Pareto-optimal Benders cut, it is necessary to solve the dual of the Magnanti-Wong Problem:

$$max {\sum }_{k ∈ ɛ} ( {\sum }_{{ɛ}_{t} ∈ δ + ( k )} {ϕ}_{{e}_{t}} + ξ {\sum }_{{e}_{t} ∈ δ + ( k )} {\overline{ϕ}}_{{e}_{t}} )$$

$$s . t . {\sum }_{{e}_{t} ∈ δ - ( i )} {ϕ}_{{e}_{t}} - {\sum }_{{e}_{t} ∈ δ + ( i )} {ϕ}_{{ϵ}_{t}} = 0 \qquad ∀ i ∈ {𝒯}^{x}$$

$$\begin{matrix}{ϕ}_{{e}_{t}} + {\overline{x}}_{e} \cdot {u}_{{e}_{t}} ( 1 + \frac{{n}^{+}}{{n}_{e}} ) \cdot ξ \leq {x}_{e}^{0} \cdot {u}_{{e}_{t}} ( 1 + \frac{{n}^{+}}{{n}_{e}} ) & ∀ e ∈ , t ∈\end{matrix}$$

$${ϕ}_{{e}_{t}} + {\overline{v}}_{{e}_{t}} \cdot {u}_{{e}_{t}} ( 1 + \frac{{\overline{z}}_{e}}{{n}_{e}} ) \cdot ξ \leq {v}_{{e}_{t}}^{0} \cdot {u}_{{e}_{t}} ( 1 + \frac{{z}_{e}^{0}}{{n}_{e}} ) \qquad ∀ e ∈ , ∀ t ∈$$

$${\sum }_{{e}_{t} ∈ δ + ( k )} {ϕ}_{{e}_{t}} + {d}_{k} \cdot ξ \leq {d}_{k} \qquad ∀ k ∈ ɛ$$

$${ϕ}_{{e}_{t}} \geq 0 \qquad ∀ {e}_{t} ∈ {x}^{}$$

where {x̅ₑ}, {z̅ₑ}, and {v̅ₑ_{ₜ}} are from the optimal solution to the RMP and {φ̅ₑ_{ₜ}} are from the optimal solution to the SP. As a core point, take

$${x}_{e}^{0} = \frac{1}{\text{?}} , ∀ i ∈ 𝒩 , ∀ e ∈ {δ}^{+} ( i )$$

$${\overline{z}}_{e}^{0} = min ( \frac{B}{\text{?}} \cdot \frac{{n}^{+}}{2} )$$

$${w}_{e}^{0} = \frac{B - 1}{\text{?}}$$

$${v}_{{e}_{t}}^{0} = \{ \begin{matrix}1 & if t < {f}_{e} + {w}_{e}^{0} - 1 \\ 0 & if t \geq {f}_{e} + {w}_{e}^{0} - 1\end{matrix} \\ \text{?} \text{indicates text missing or illegible when filed}$$

Note that this is not a true core point, since the unfixed {vₑ_{ₜ}^{o}} should strictly decrease with time due to constraints (22). However, this would cause issues with numerical precision. The Benders cuts use dual variables from the Magnanti-Wong Problem, which means {yₑ_{ₜ}}, { [symbol] ₑ_{ₜ}′}, and { [symbol] k} are the dual variables of the three inequality constraints. Further information regarding the Magnanti-Wong method may be found in their article entitled “Accelerating benders decomposition:Algorithmic enhancement and model selection criteria” Operaions Research 29(3):464-484 (1981).

As a proof of concept, the MIP and the Benders decomposition approaches were applied to the evacuation of the Hawkesbury-Nepean (HN) floodplain, located near Sydney. This region is a large floodplain protected by the Warrangaba Dam from the Blue Mountains where precipitation accumulates. The dam spills over every year and the authorities are worried about the need to evacuate the flood plain which hosts about 80,000 people. Consider a number of worst-case scenarios where a significant (1 in 100 years) flood would reach the flood plain after 5, 6, or 7 hours, respectively, and uses the flood extent as computed by standard 2D hydro-dynamic flood stimulation models. The road infrastructure consists of 80 evacuation nodes, 184 transit nodes, 5 safe nodes, and 580 arcs. The time horizon was discretized into 5 minute intervals. The upgrade costs were taken to be 5 units per kilometer of additional lanes built and 0.01 units per kilometer for elevating a road to extend its availability by one time step. Unless otherwise stated, the budget is 100 units. The population was scaled by a factor x∈[1.7,3] to model population growth in the Hawkesbury-Nepean region. Each instance was run for up to one hour. The algorithms described above were implemented using JAVA 8 with GUROBI 6.0 and run on a 64 bit machine with a 1.4 GHz Intel Core 15 processor and 4 GB of RAM under OSX 10.10.5.

Table 1 below compares the percent evacuated by the Benders decomposition and the MIP model (1 h) on four population instances and three flood scenarios. The CPU times correspond to when the best FSP value was found by the Benders decomposition. The LRMP is the last Restricted Master Problem solution, and BD is the Benders decomposition solution. Column BD10 is the best Benders decomposition solution after 10 minutes. The gap between the LRMP and best BD and is calculated as

$$\frac{z ( LRMP ( 𝒢 , ℋ , ℬ ) ) - z ( BD ( 𝒢 , ℋ , ℬ ) )}{z ( BD ( 𝒢 , ℋ , ℬ ) )} .$$

Column % Imp is the improvement of the Benders approach over the MIP model in percentage.

| | Benders Decomposition | | | | | MIP | |
|---|---|---|---|---|---|---|---|
| | CPU | LRMP | BD | BD10 | Gap | Perc. | % |
| Instance | (s) | (%) | (%) | (%) | (%) | Evac. | Imp |
| HN-1.7 | | | | | | | |
| 300 min | 200.0 | 100 | 96.9 | 96.9 | 3.2 | 87.5 | 10.7 |
| 360 min | 755.1 | 100 | 98.8 | 98.5 | 1.2 | 99.2 | −0.4 |
| 420 min | 992.0 | 100 | 100 | 99.6 | 0 | 99.0 | 1.0 |
| HN-2.0 | | | | | | | |
| 300 min | 1843.4 | 100 | 95.6 | 95.9 | 3.5 | 89.4 | 8.1 |
| 360 min | 593.7 | 100 | 98.9 | 98.9 | 1.2 | 91.7 | 7.8 |
| 420 min | 2343.9 | 100 | 100 | 98.4 | 0 | 87.9 | 13.7 |
| HN-2.5 | | | | | | | |
| 300 min | 2283.6 | 100 | 90.3 | 88.9 | 10.7 | 78.6 | 14.9 |
| 360 min | 3472.1 | 100 | 95.5 | 94.0 | 4.7 | 82.5 | 15.8 |
| 420 min | 1983.2 | 100 | 97.5 | 96.3 | 2.6 | 80.7 | 18.4 |
| HN-3.0 | | | | | | | |
| 300 min | 3426.7 | 100 | 80.4 | 80.2 | 24.4 | 65.6 | 22.5 |
| 360 min | 1874.4 | 100 | 85.4 | 84.2 | 17.2 | 67.9 | 25.8 |
| 420 min | 1566.2 | 100 | 90.9 | 87.1 | 10.0 | 70.6 | 28.9 |

The duality gaps are quite small for instance HN-1.7, but increase with the population growth. The Benders decomposition performs better than the MIP model on all but one instance. The difference in quality grows as the population increases, with the Benders decomposition evacuating about 29% more people on the last instance. The Benders decomposition after 10 minutes also improves the MIP in all instances except one, evacuating up to 23% more people.

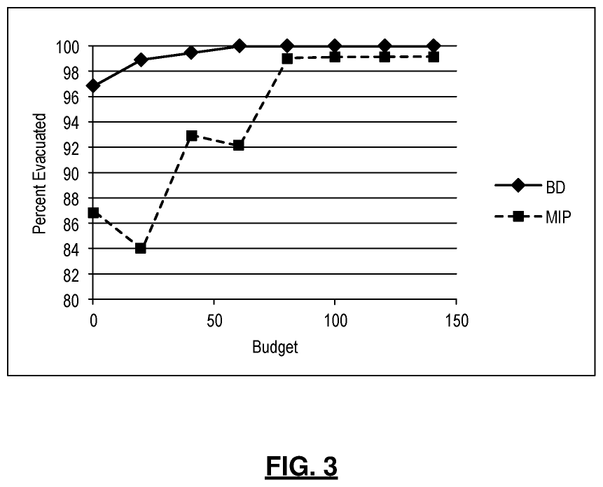

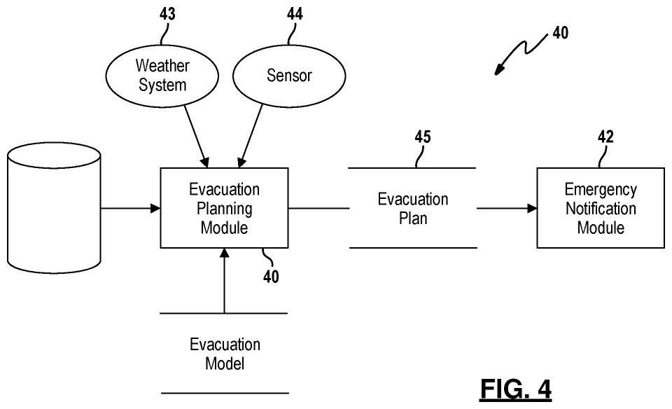

FIG. 3 shows the effect of varying the budget parameter for instance 1.7 with a flood arriving at the 360 minute mark, a profile emergency services are keen to study. The graph shows that the performance of MIP model degrades substantially when the budget is tight and performs reasonably when the budget is sufficiently large to evacuate everyone. In contrast, the Benders formulation produces excellent results for all budgets. This confirms the findings of Table 1, where the quality differences between the Benders decomposition and the MIP model increase with population growth. This is especially relevant, since infrastructure improvement projects traditionally operate under tight budgets.

FIG. 4 depicts an example system 40 for determining and implementing an evacuation plan. The system is comprised of an evacuation planning module 41 and an emergency notification module 42. As used herein, the term module may refer to, be part of, or include an Application Specific Integrated Circuit (ASIC), an electronic circuit, a processor (shared, dedicated, or group) and/or (shared, dedicated or group) that execute one or more software or firmware programs, a combinational logic circuit, and/or other suitable components that provide the described functionality.

The evacuation planning module 41 receives various inputs which may be used to construct an evacuation scenario. For example, the evacuation planning module 41 may retrieve data which describes the area to be evacuated, including but not limited to locations of potential evacuees, locations of possible destinations for the evacuees, locations that evacuees pass through when traveling to the destinations. The data may further describe the paths (e.g., roads) between these different locations as well as the capacity of the paths or transport between the locations. The evacuation planning module 41 may also receive input that helps to define the evacuation scenario via a user interface from a user. For example, the user may input the time period over which the evacuation is to occur or the time increments in which to perform the analysis. From this data, the evacuation scenario can be represented by the evacuation planning module 41 with a graph as described above

In some embodiments, the evacuation planning module 41 may be configured to receive data in real-time, for example from a weather system 43 or sensors 44 located in the evacuation area. By way of example, a sensor may be used to measure water flow over a dam or a weather system may provide a projected time at which a hurricane will arrive at the evacuation area or an amount of rain a hurricane will bring to the evacuation area. This data may be used to update evacuation plan in real-time, for example as an event is occurring. These examples are merely illustrative of the types of data which may be used to define the evacuation scenario.

Given suitable inputs, the evacuation planning module 41 will in turn determine and output an evacuation plan 45. To do so, an evacuation module 46 is also made accessible to the evacuation planning module 41. In the example embodiment, the evacuation module 46 is either the MIP model of the Bender decomposition module described above. Likewise, the evacuation planning module 41 determines the evacuation plan 45 using either the MIP approach or the Bender decomposition approach set forth above.

The emergency notification module 42 is configured to receive the evacuation plan 45 from the evacuation planning module. Of note, the resulting evacuation plan 45 includes a schedule of departure times for evacuees at different locations in the evacuation area. The emergency notification module may operate to send notifications to the evacuees, for example advising them of a mandatory evacuation time, a destination as well as a suggested path for reaching the destination. In one embodiment, the notification is a text message or an email message sent directly to the evacuee. Notifications may be sent are various times during the evacuation process and include updates or changes to the evacuation time, the destination and/or the suggested path for reaching the destination. Different forms for the notification are also contemplated by this disclosure.

The evacuation plan also includes infrastructure upgrades, such as adding lanes to a road or elevating the road. Likewise, these infrastructure upgrades may be communicated to the applicable governmental entity (e.g., a road commission) responsible for implementing the infrastructure upgrade. In some instances, the infrastructure upgrades may require immediate implementation, such as lining a road with sandbags, and thus communicated to the responsible parties using the emergency notification module 42.

In this disclosure, the Convergent Evacuation Network Design Problem (CENDP) was introduced for creating convergent evacuation plans with infrastructure upgrades. A MIP model and a Benders decomposition approach were proposed for solving the CENDP. The approaches were tested on a case study for a flood plain West of Sydney where the road infrastructure has not kept up with population growth, creating significant concerns from emergency services. Experimental results show that the Benders decomposition performed significantly better than the MIP model, evacuating as much as 28.9% more people on the instances with higher population growth. Varying the budget for an easier instance revealed the large gap in solution quality between the Benders approach and the MIP model, especially when the budget is tight which is the typical case in infrastructure improvement studies.

Overall, the results show that Benders decomposition provides a novel tool for emergency services that seek to improve their road infrastructure to meet the evacuation needs coming from increased urbanization.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A method for determining an evacuation plan, comprising:
a) representing an evacuation scenario with an evacuation graph, wherein the evacuation graph is comprised of evacuation nodes, transit nodes and safe nodes interconnected by edges, such that each evacuation node has a number of evacuees, each safe node is a possible destination for evacuees, the transit nodes are locations evacuees pass through when traveling from the evacuation nodes to the safe nodes, and each edge represents a path between nodes and has a capacity for evacuees traversing that path;
b) segmenting an evacuation time period into a plurality of time blocks;
c) constructing a time-expanded graph from the evacuation graph by duplicating each node in the evacuation graph for each time block in the plurality of time blocks and connecting an origin node in a given time period via an edge to a destination node at a subsequent time period as determined by the time needed to traverse this edge, where each edge in the time-expanded graph includes a continuous flow variable representing flow on that edge, and an upgrade variable indicating an infrastructure upgrade to the path represented by that edge;
d) determining a set of convergent subgraphs of the time-expanded graph that maximize the flow of evacuees from all of the evacuation nodes to the safe nodes and identifies any infrastructure upgrades along the route, where each evacuation node is found in at least one convergent subgraphs in the set of convergent subgraphs; and
e) scheduling departure times for evacuees that maximizes the flow of evacuees from the evacuation nodes to the safe nodes in the convergent graph.

2. The method of claim 1 wherein each edge in the evacuation graph represents a road between nodes and the infrastructure upgrade is further defined as adding lanes to an existing road or elevating the road.

3. The method of claim 2 further comprises defining a model for solving the evacuation scenario, where an objective of the model is to maximize the flow of evacuees from all of the evacuation nodes to the safe nodes and decision variables in the model include a binary variable indicating whether a given edge is selected for inclusion in a route between a given evacuation node and a given safe node, a continuous flow variable representing flow on the given edge, a first upgrade variable indicating a number of lanes added to the road represented by the given edge and a second upgrade variable indicating whether the road is available at a given time according to its elevation.

4. The method of claim 1 wherein determining a set of convergent subgraphs further comprises aggregating, for each edge in the evacuation graph, capacity of the corresponding one or more edges in the time-expanded graph over the evacuation time period and thereby form a master problem graph, such that each edge in the master problem graph includes an aggregated capacity for evacuees traversing that edge.

5. The method of claim 1 wherein determining a set of convergent subgraphs requires flow conservation at each of the transit nodes in the time-expanded graph and enforces aggregated capacity associated with each edge in the time-expanded graph.

6. The method of claim 5 further comprises determining a set of convergent subgraphs by constraining flow on a given edge by capacity, where capacity increases linearly with number of lanes comprising the road.

7. The method of claim 1 further comprises determining a set of convergent subgraphs using a branch and bound method.

8. The method of claim 4 wherein scheduling departure times for evacuees requires flow conservation at each of the transit nodes in the master problem graph and enforces aggregated capacity associated with each edge in the master problem graph.

9. The method of claim 1 further comprises scheduling departure times for evacuees using a linear programming method.

10. The method of claim 1 further comprises
determining a first number of evacuees reaching the safe nodes within the evacuation time period using the set of convergent subgraphs;
determining a second number of evacuees reaching the safe nodes within the evacuation time period using the scheduled departure times;
comparing the first number of evacuees to the second number of evacuees; and
adding constraints to the step of determining a set of convergent subgraphs and repeating steps (d) and (e) until the first number of evacuees matches the second number of evacuees.

11. The method of claim 10 wherein adding constraints further comprises generating Bender cuts and adding the Bender cuts as a constraint to the step of determining a set of convergent subgraphs.

12. The method of claim 1 further comprises implementing the identified infrastructure upgrades along the routes.

13. A method for determining an evacuation plan, comprising:
a) receiving data describing an evacuation scenario;
b) constructing an evacuation graph for the evacuation scenario with an evacuation graph, wherein the evacuation graph is comprised of evacuation nodes, transit nodes and safe nodes interconnected by edges, such that each evacuation node has a number of evacuees, each safe node is a possible destination for evacuees, the transit nodes are locations evacuees pass through when traveling from the evacuation nodes to the safe nodes, and each edge in the evacuation graph represent a road between nodes and has a capacity for evacuees traversing that road;
c) segmenting an evacuation time period into a plurality of time blocks;
d) generating a time-expanded graph from the evacuation graph by duplicating each node in the evacuation graph for each time block in the plurality of time blocks and connecting an origin node in a given time period and an destination node at a subsequent time period so long as the road remains available for use at the given time period, where each edge in the time-expanded graph includes a continuous flow variable representing flow on that edge, and an upgrade variable indicating an infrastructure upgrade to the road represented by that edge;
e) determining a set of convergent subgraphs of the time-expanded graph that maximize the flow of evacuees from all of the evacuation nodes to the safe nodes and thereby identifies infrastructure upgrades to the roads, where each evacuation node is found in at least one convergent subgraphs in the set of convergent subgraphs; and
f) implementing the identified infrastructure upgrades to the roads.

14. The method of claim 13 further comprises determining the set of convergent subgraphs in accordance with a model, where an objective of the model is to maximize the flow of evacuees from all of the evacuation nodes to the safe nodes and decision variables in the model include a binary variable indicating whether a given edge is selected for inclusion in a route between a given evacuation node and a given safe node, a continuous flow variable representing flow on the given edge, a first upgrade variable indicating a number of lanes added to the road represented by the given edge and a second upgrade variable indicating whether the road is available at a given time according to its elevation.

15. The method of claim 14 wherein determining the set of convergent subgraphs further comprises aggregating, for each edge in the evacuation graph, capacity of corresponding edges in the time-expanded graph over the evacuation time period and thereby forming a master problem graph, such that each edge in the master problem graph includes an aggregated capacity for evacuees traversing that edge.

16. The method of claim 15 wherein determining the set of convergent subgraphs requires flow conservation at each of the transit nodes in the time-expanded graph and enforces aggregated capacity associated with each edge in the time-expanded graph.

17. The method of claim 15 further comprises determining the set of convergent subgraphs by constraining flow on a given edge by capacity, where capacity increases linearly with number of lanes comprising the road.

18. The method of claim 15 further comprises determining the set of convergent subgraphs using a branch and bound method.

19. The method of claim 15 further comprises scheduling departure times for evacuees that maximizes the flow of evacuees from the evacuation nodes to the safe nodes in the convergent graph using a linear programming method.

20. The method of claim 19 wherein scheduling departure times for evacuees requires flow conservation at each of the transit nodes in the master problem graph and enforces aggregated capacity associated with each edge in the master problem graph.
